(19) United States
(12) Patent Application Publication
(10) Pub. No.: US 2024/0332747 A1
(43) Pub. Date: Oct. 3, 2024

(54) RECHARGEABLE BATTERY PACK

(71) Applicant: SAMSUNG SDI CO., LTD., Yongin-si (KR)

(72) Inventor: Hyun KIM, Yongin-si (KR)

(21) Appl. No.: 18/457,220

(22) Filed: Aug. 28, 2023

(30) Foreign Application Priority Data
Apr. 3, 2023 (KR) 10-2023-0043657

(51) Int. Cl. H01M 50/503; H01M 50/209; H01M 50/507

(52) U.S. Cl. CPC H01M 50/503; H01M 50/209; H01M 50/507

(57) ABSTRACT

A rechargeable battery pack includes: a cell assembly including a number of battery cells each having a first electrode terminal and a second electrode terminal, a frame portion configured to accommodate the cell assembly; and a bus bar module including a number of bus bars positioned at an upper portion of the cell assembly and electrically connecting at least two electrode terminals to each other. The bus bar module may include: a first bus bar module including a number of bus bars electrically connecting the electrode terminals to each other at a first side of the cell assembly; and a second bus bar module including a number of bus bars electrically connecting the electrode terminals to each other at a second side of the cell assembly.

### CROSS-REFERENCE TO RELATED APPLICATION

This application claims priority to and the benefit of Korean Patent Application No. 10-2023-0043657, filed in the Korean Intellectual Property Office on Apr. 3, 2023, the entire contents of which are incorporated herein by reference.

### BACKGROUND

### 1. Field

The present disclosure relates to a rechargeable battery pack capable of simplifying a connection structure of bus bars and reducing a temperature rise of the bus bars.

### 2. Description of the Related Art

A rechargeable battery can be repeatedly charged and discharged, unlike a primary battery. Small-capacity rechargeable batteries are used in portable electronic devices such as mobile phones, notebook computers, and camcorders. Large-capacity and high-density rechargeable batteries are used for power for motor driving of hybrid vehicles and electric vehicles, or energy storage.

A rechargeable battery includes an electrode assembly for charging and discharging a current; a case for accommodating the electrode assembly and an electrolyte; and an electrode terminal connected to the electrode assembly and extending out of the case. The electrode assembly may be formed in a jelly roll type configuration by winding an electrode and a separator.

The rechargeable battery may be used as one unit battery cell, but may be used as a rechargeable battery pack in which plurality of unit battery cells are connected in parallel or in series in order to achieve a large capacity. For example, the rechargeable battery pack may utilize a bus bar for connecting the unit battery cells in series or in parallel, and may have a structure in which a current is drawn from one tab.

In the case of using a plurality of unit battery cells, the rechargeable battery pack should have a structure capable of effectively dissipating heat generated during charging and discharging for high output response, and a structure capable of effectively fixing the unit battery cells in response to shock and vibration.

However, in a process of electrically connecting the plurality of unit battery cells using a plurality of bus bars, there is a problem in that a temperature rise frequently occurs due to a complicated connection of the bus bars.

### SUMMARY

An embodiment of the present disclosure includes a rechargeable battery pack capable of preventing excessive temperature rise at a connection position of bus bars by reducing a number of bus bars and simplifying an installation length.

An embodiment of the present disclosure provides a rechargeable battery pack including: a cell assembly including a number of battery cells and a number of electrode terminals each including a first electrode terminal and a second electrode terminal protruding upward from the respective battery cell; a frame portion configured to accommodate the cell assembly; and a bus bar module including a number of bus bars positioned at an upper portion of cell assembly and electrically connecting at least two electrode terminals to each other.

The bus bar module may include: a first bus bar module including a number of bus bars electrically connecting the electrode terminals to each other at a first side of the cell assembly; and a second bus bar module including a number of bus bars electrically connecting the electrode terminals to each other at a second side of the cell assembly.

Side surfaces of the battery cells may be in contact with each other along a first direction.

The battery cells may include first to fourth sets of battery cells in which electrode terminals of a same polarity are positioned adjacent to each other and a pair of battery cells form a set.

The first to fourth sets of battery cells may be positioned such that electrode terminals of different polarities are adjacent to each other in a state of being positioned adjacent to each other along the first direction.

The first bus bar module may include: a first bus bar positioned along a first side of the cell assembly to have a first side that is electrically connected to a first electrode terminal of the first set of battery cells and a second side that is electrically connected to a second electrode terminal of the fourth set of battery cells; and a second bus bar positioned on a side surface of the first bus bar to have a first side that is electrically connected to a second electrode terminal of the second set of battery cells and a second side that is electrically connected to a first electrode terminal of the third set of battery cells.

The second bus bar module may include: a third bus bar positioned along a second side of the cell assembly to have a first side that is electrically connected to a second electrode terminal of the first set of battery cells and a second side that is electrically connected to a first electrode terminal of the second set of battery cells; and a fourth bus bar positioned along the second side of the cell assembly to have a first side that is electrically connected to a second electrode terminal of the third set of battery cells, and a second side that extends to the outside of the cell assembly; a fifth bus bar positioned on a side surface of the fourth bus bar to have a first side that is electrically connected to a first electrode terminal of the fourth set of battery cells, and a second side that extends to the outside of the fourth set of battery cells.

The first bus bar may include: a first body positioned at upper portions of first sides of the first to fourth sets of battery cells at first sides on the first side of the cell assembly; a first protrusion protruding from a side surface of the first body at a first end and electrically connected to the first electrode terminal of the first set of battery cells; and a second protrusion protruding from a side surface of the first body at a second end and electrically connected to the second electrode terminal of the fourth set of battery cells.

The first protrusion may include a pair of first protrusions on the side surface of the first body at a first end and electrically connected to the first electrode terminal of the first set of battery cells.

The second protrusion may include a pair of second protrusions on the side surface of the first body at a second end and electrically connected to the second electrode terminal of the fourth set of battery cells.

The second bus bar may include: a second body positioned at upper portions of the second set of battery cells and the third set of battery cells at a position spaced apart from the side surface of the first body; a third protrusion protruding from a side surface of the second body and electrically connected to the second electrode terminal of the second set of battery cells; and a fourth protrusion protruding from a side surface of the second body and electrically connected to the first electrode terminal of the third set of battery cells.

The third protrusion may include a pair of third protrusions on the side surface of the second body and electrically connected to a second electrode terminal of the second set of battery cells.

The fourth protrusion may include a pair of fourth protrusions on the side surface of the second body and electrically connected to the first electrode terminal of the third set of battery cells.

The third bus bar may include: a third body positioned at upper portions of the first set of battery cells and the second set of battery cells along the second side of the cell assembly; a fifth protrusion protruding from a side surface of the third body and electrically connected to a second electrode terminal of the first set of battery cells; and a sixth protrusion protruding from the side surface of the third body and electrically connected to the first electrode terminal of the second set of battery cells.

The fifth protrusion may include a pair of fifth protrusions on the side surface of the second body and electrically connected to the second electrode terminal of the first set of battery cells.

The sixth protrusion may include a pair of sixth protrusions on the side surface of the second body and electrically connected to the first electrode terminal of the third set of battery cells.

The fourth bus bar may include: a fourth body positioned at upper portions of the third set of battery cells and the fourth set of battery cells along the second side of the cell assembly; and a seventh protrusion protruding from a side surface of the fourth body and electrically connected to the second electrode terminal of the third set of battery cells.

The fourth body may be connected to the first current collector outside the fourth set of battery cells.

The seventh protrusion may include a pair of seventh protrusions on the side surface of the fourth body and electrically connected to the second electrode terminal of the third set of battery cells.

A portion of the fourth body may be positioned at upper portions of the fourth set of battery cells in a state in which the fourth set of battery cells are not electrically connected thereto.

The fifth bus bar may include: a fifth body spaced apart from a side surface of the fourth bus bar and positioned at the upper portions of the fourth set of battery cells; and an eighth protrusion protruding from the side surface of the fifth body and electrically connected to the first electrode terminal of the fourth set of battery cells.

The eighth protrusion may include a pair of eighth protrusions on the side surface of the fifth body and electrically connected to the first electrode terminal of the fourth set of battery cells.

The fifth body may be connected to the second current collector outside the fourth set of battery cells.

The cell assembly may include two cell assemblies that are installed inside the frame portion and positioned in opposite directions.

According to an embodiment of the present disclosure, the electrode terminals of adjacent battery cells may have different polarities along a first direction.

The cell assembly may include first to eighth battery cells positioned adjacent to each other along a first direction.

The first bus bar module may include: a first parallel bus bar positioned along a first side of the cell assembly and electrically connected to an electrode terminal of each of the first battery cell, the third battery cell, the sixth battery cell, and the eighth battery cell; and a first parallel bus bar positioned on a side surface of the first parallel bus bar along the first side of the cell assembly and electrically connected to an electrode terminal of each of the second battery cell, the fourth battery cell, the fifth battery cell, and the seventh battery cell.

The second bus bar module may include: a third parallel bus bar positioned along the second side of the cell assembly and electrically connected to the electrode terminal of each of the first battery cell, the second battery cell, the third battery cell, and the fourth battery cell; a fourth parallel bus bar positioned along the second side of the cell assembly and electrically connected to the electrode terminal of each of the fifth battery cell and the seventh battery cell; and a fifth parallel bus bar positioned on a side surface of the fourth parallel bus bar along the second side of the cell assembly and electrically connected to the electrode terminal of each of the sixth battery cell and the eighth battery cell.

The first parallel bus bar may include: a first bus bar body positioned along the first side of the cell assembly and positioned at upper portions of the first to eighth battery cells at first sides; a first connector protruding from a side surface of the first bus bar body and electrically connected to the first electrode terminal of the first battery cell; a second connector protruding from the side surface of the first bus bar body and electrically connected to the first electrode terminal of the third battery cell; a third connector protruding from the side surface of the first bus bar body and electrically connected to the second electrode terminal of the sixth battery cell; and a fourth connector protruding from a side surface of the first bus bar body and electrically connected to the second electrode terminal of the eighth battery cell.

The second parallel bus bar may include: a second bus bar body positioned on the side surface of the first bus bar body along the first side of the cell assembly and positioned at upper portions of the second to seventh battery cells at first sides; a fifth connector protruding from a side surface of the second bus bar body, to be electrically connected to a second electrode terminal of the second battery cell; a sixth connector protruding from a side surface of the second bus bar body and electrically connected to a second electrode terminal of the fourth battery cell; a seventh connector protruding from the side surface of the second bus bar body and electrically connected to a first electrode terminal of the fifth battery cell; and a eighth connector protruding from a side surface of the second bus bar body and electrically connected to the first electrode terminal of the seventh battery cell.

The third parallel bus bar may include: a third bus bar body positioned along the second side of the cell assembly and positioned at upper portions of the first to fourth battery cells at second sides; a ninth connector protruding from the side surface of the third bus bar body and electrically connected to a second electrode terminal of the first battery cell; an tenth connector protruding from the side surface of the third bus bar body and electrically connected to a first electrode terminal of the second battery cell; an eleventh connector protruding from the side surface of the third bus bar body and electrically connected to a second electrode terminal of the third battery cell; and a twelfth connector protruding from a side surface of the third bus bar body and electrically connected to the first electrode terminal of the fourth battery cell.

The fourth parallel bus bar may include: a fourth bus bar body positioned along the second side of the cell assembly and positioned at upper portions of the fifth to eighth battery cells; a 13^{th} connector protruding from the side surface of the fourth bus bar body and electrically connected to a second electrode terminal of the fifth battery cell; and a 14^{th} connector protruding from the side surface of the fourth bus bar body and electrically connected to a second electrode terminal of the seventh battery cell.

The fourth bus bar body may be connected to the first current collector outside the eighth battery cell.

The fifth parallel bus bar may include: a fifth bus bar body positioned along the second side of the cell assembly and positioned at upper portions of the sixth to eighth battery cells; a 15^{th} connector protruding from the side surface of the fifth bus bar body and electrically connected to a first electrode terminal of the sixth battery cell; and a 16^{th} connector protruding from the side surface of the fifth bus bar body and electrically connected to a first electrode terminal of the eighth battery cell.

The fifth bus bar body may be connected to the second current collector outside the eighth battery cell.

The cell assembly may include two cell assemblies that are installed inside the frame portion and positioned in opposite directions.

According to an embodiment of the present disclosure, it is possible to appropriately reduce heat generation due to current flowing along the bus bar by eliminating a bus bar crossing between opposite sides of the cell assembly and reducing an installed length and the number of the bus bars compared to related art rechargeable batteries.

### BRIEF DESCRIPTION OF THE DRAWINGS

FIG. 1 illustrates a schematic perspective view showing a rechargeable battery pack according to a first embodiment of the present disclosure.

FIG. 2 illustrates a schematic top plan view showing a rechargeable battery pack illustrated in FIG. 1.

FIG. 3 illustrates a schematic top plan view showing a first bus bar module of the rechargeable battery pack of FIG. 1.

FIG. 4 illustrates a schematic top plan view showing a second bus bar module of the rechargeable battery pack of FIG. 1.

FIG. 5 illustrates a schematic perspective view showing a rechargeable battery pack according to a second embodiment of the present disclosure.

FIG. 6 illustrates a schematic top plan view showing the rechargeable battery pack illustrated in FIG. 5.

FIG. 7 illustrates a schematic top plan view showing a first bus bar module of the rechargeable battery pack of FIG. 5.

FIG. 8 illustrates a schematic top plan view showing a second bus bar module of the rechargeable battery pack of FIG. 5.

### DETAILED DESCRIPTION

Hereinafter, the present disclosure will be described more fully with reference to the accompanying drawings, in which embodiments of the disclosure are shown. As those skilled in the art would realize, the described embodiments may be modified in various different ways, all without departing from the spirit or scope of the present disclosure. The drawings and description are to be regarded as illustrative in nature and not restrictive. Like reference numerals designate like elements throughout the specification.

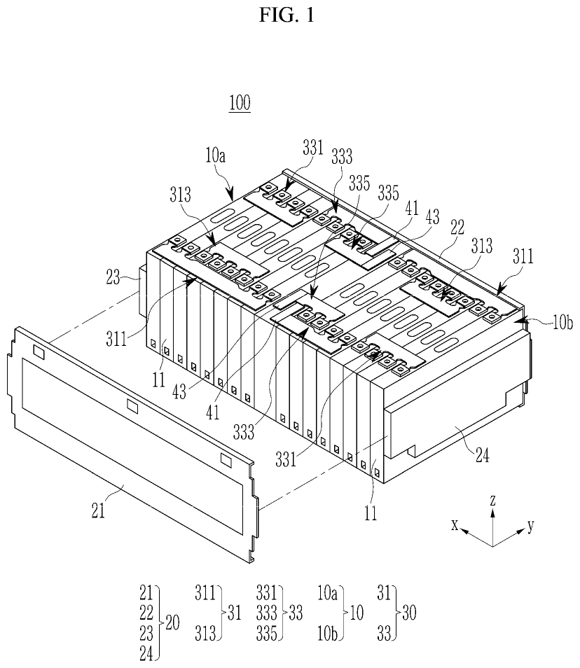

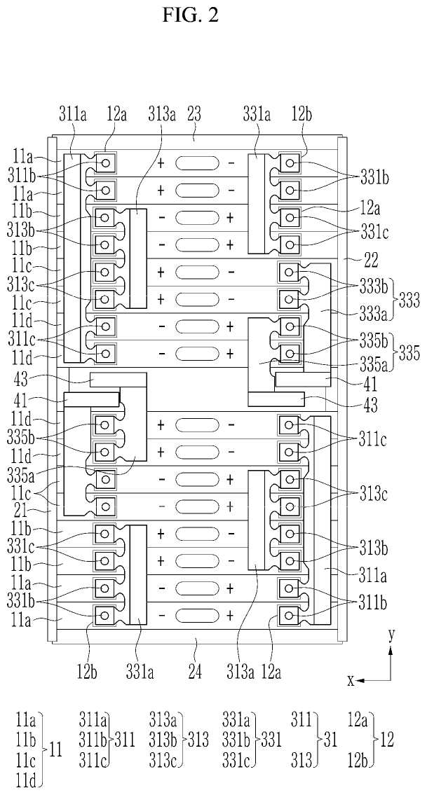

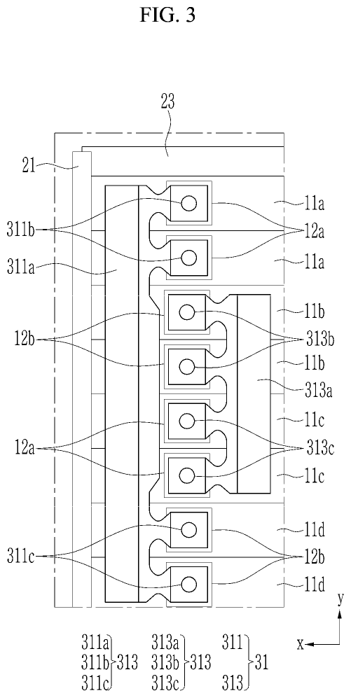

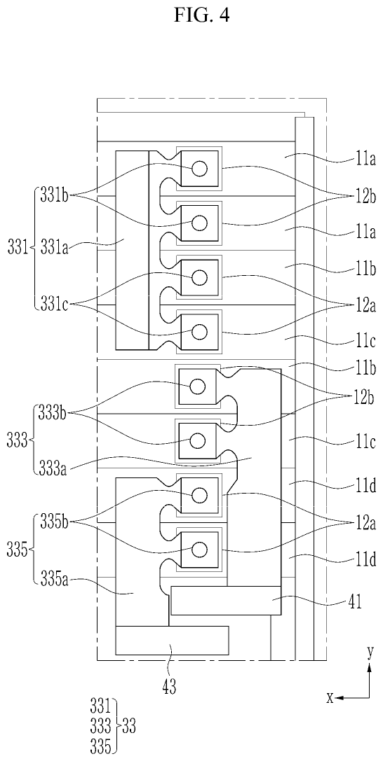

FIG. 1 illustrates a schematic perspective view showing a rechargeable battery pack according to a first exemplary embodiment of the present disclosure, FIG. 2 illustrates a schematic top plan view showing a rechargeable battery pack illustrated in FIG. 1, FIG. 3 illustrates a schematic top plan view showing a first bus bar module of the rechargeable battery pack of FIG. 1, and FIG. 4 illustrates a schematic top plan view showing a second bus bar module of the rechargeable battery pack of FIG. 1.

As illustrated in FIG. 1 to FIG. 4, the rechargeable battery pack 100 according to the first embodiment of the present disclosure includes a cell assembly 10 including a plurality of battery cells 11 and having electrode terminals 12 each including a first electrode terminal 12a and a second electrode terminal 12b protruding upward from the respective battery cells 11 and a bus bar module 30 including a plurality of bus bars positioned at an upper portion of the cell assembly 10 and electrically connecting at least two electrode terminals 12 to each other.

The battery cells 11 may be formed to include conventional rechargeable batteries that repeatedly perform charging and discharging operations. In the first embodiment, the battery cells 11 will be described by using an example in which eight battery cells 11 are electrically connected to the bus bar module 30 to form the cell assembly 10.

The battery cells 11 may be electrically connected by the bus bar module 30 in a configuration in which four sets are formed by forming sets of every two out of eight battery cells 11.

That is, the cell assembly 10 according to the first embodiment may include first to fourth sets 11a to 11d of battery cells in which eight battery cells 11 form four sets 11a to 11d.

In each of the first to fourth sets 11a to 11d of battery cells 11, a pair of battery cells 11 may be positioned in a configuration in which electrode terminals having the same polarity are positioned adjacent to each other.

In addition, the first to fourth sets 11a to 11d of battery cells 11 may be positioned inside a frame portion 20 with their sides adjacent to each other, and each of the first to fourth sets 11a to 11d of battery cells 11 may be positioned in a configuration in which electrode terminals of different polarities are positioned adjacent to each other.

That is, an example in which the eight battery cells 11 are disposed adjacent to each other, a pair of adjacent battery cells is a first set 11a of battery cells, another pair of battery cells adjacent to the first set 11a of battery cells is a second set 11b of battery cells, another pair of battery cells adjacent to the second set 11b of battery cells is a third set 11c of battery cells, and a remaining pair of battery cells adjacent to the third set 11c of battery cells is a fourth set 11d of battery cells will be described.

As such, the first to fourth sets 11a to 11d of battery cells, in which eight battery cells are arranged in four pairs, may be electrically connected to each other by the bus bar module 30 and accommodated inside the frame portion 20.

Additionally, the cell assembly 10 of the rechargeable battery pack 100 according to the first embodiment may be installed inside the frame portion 20 in a configuration in which two cell assemblies 10a and 10b are positioned to face each other.

The cell assembly 10 may include a first cell assembly 10a inserted into the frame portion 20 and a second cell assembly 10b connected to the first cell assembly 10a. In one or more embodiments, the first cell assembly 10a and the second cell assembly 10b may have a same configuration, and may be inserted into the frame portion 20 in different directions. In the following description, the same reference numbers are used for major components of the first cell assembly 10a and the second cell assembly 10b.

In the cell assembly 10, a first bus bar module 31 of the first cell assembly 10a and a second bus bar module 33 of the second cell assembly 10b may be positioned on a straight line at a first side of the cell assembly 10 in a configuration where the first cell assembly 10a and the second cell assembly 10b are inserted into the frame portion 20.

In addition, the second bus bar module 33 of the first cell assembly 10a and the first bus bar module 31 of the second cell assembly 10b may be positioned on a straight line at a second side of the cell assembly 10.

The frame portion 20 includes a first side frame 21 supporting first sides of the battery cells 11, a second side frame 22 opposite to the first side frame 21 and supporting second sides of the battery cells 11, a first end frame 23 having opposite ends respectively connected to first ends of the first side frame 21 and the second side frame 22, and a second end frame 24 opposite to the first end frame 23 and having opposite ends respectively connected to second ends of the first side frame 21 and the second side frame 22.

The first side frame 21 may be installed to support the first sides of the battery cells 11.

The second side frame 22 may be installed to support the second sides of the battery cells 11.

The first end frame 23 may be installed to connect between a first end of each of the first side frame 21 and the second side frame 22. That is, a first end of the first end frame 23 may be connected to a first end of the first side frame 21 by a fastening member, and a second end thereof may be connected to a first end of the second side frame 22 by the fastening member.

The second end frame 24 may be installed to connect between a second end of each of the first side frame 21 and the second side frame 22. That is, a first end of the second end frame 24 may be connected to a second end of the first side frame 21 by the fastening member, and a second end thereof may be connected to a second end of the second side frame 22 by the fastening member.

Additionally, the battery cells 11 of the cell assembly 10 are electrically connected by the bus bar module 30 in a configuration positioned inside the frame portion 20.

The bus bar module 30 may include a first bus bar module 31 electrically connecting a plurality of battery cells at a first side of the cell assembly 10, and a second bus bar module 33 electrically connecting a plurality of battery cells at a second side of the cell assembly 10. The second bus bar module 33 is not directly connected to the first bus bar module 31.

The first bus bar module 31 may include a plurality of bus bars electrically connecting a plurality of electrode terminals to each other at a first side edge of the cell assembly 10.

In one or more embodiments, the first bus bar module 31 may include a first bus bar 311 and a second bus bar 313 electrically connected to electrode terminals along a first side edge of the cell assembly 10.

The first bus bar 311 and the second bus bar 313 may be positioned adjacent to the first side edge of the cell assembly 10 in a non-contact state in which each are electrically connected to the electrode terminal 12. In one or more embodiments, the first electrode terminal 12a may be a positive terminal, and the second electrode terminal 12b may be a negative terminal. In one or more embodiments, the first electrode terminal 12a may be a negative terminal, or the second electrode terminal 12b may be a positive terminal.

The first bus bar 311 may be positioned along a first side of the cell assembly 10, and may have a first side that is electrically connected to the first electrode terminal 12a of the first set 11a of battery cells, and a second side that is electrically connected to the second electrode terminal 12b of the fourth set 11d of battery cells.

The first bus bar 311 may include a first body 311a positioned at upper portions of the first to fourth sets 11a, 11b, 11c, and 11d of battery cells at first sides on a first side of the cell assembly 10, a first protrusion 311b protruding from a side surface of the first body 311a at a first end that is electrically connected to the first electrode terminal 12a of the first set 11a of battery cells, and a second protrusion 311c protruding from a side surface of the first body 311a at a second end that is electrically connected to the second electrode terminal 12b of the fourth set 11d of battery cell.

The first body 311a may be formed to have a sufficiently long length so as to cross an upper portion of the first to fourth sets 11a to 11d of battery cells from an upper portion of a first side edge of the cell assembly 10.

The first protrusion 311b may protrude from a side surface of the first body 311a at a first end and be electrically connected to the first electrode terminal 12a of each of the battery cells 11 in the first set 11a of battery cells.

The first protrusion 311b may protrude as a pair of protrusions on the side surface of the first body 311a at the first end and may be electrically connected to each of a pair of first electrode terminals 12a of the first set 11a of battery cells (including two battery cells 11) by welding or the like.

The second protrusion 311c may protrude from a side surface of the first body 311a at a second end and be electrically connected to a pair of second electrode terminals 12b of the fourth set 11d of battery cells.

The second protrusion 311c may protrude as a pair of protrusions on the side surface of the first body 311a at the second end and may be electrically connected to each of a pair of second electrode terminals 12b of the fourth set 11d of battery cells (including two battery cells 11) by welding or the like.

Additionally, the second bus bar 313 may be positioned at a first side edge of the cell assembly 10 at a position between the first protrusion 311b and the second protrusion 311c of the first bus bar 311.

In one or more embodiments, the second bus bar 313 may include a second body 313a positioned at upper portions of the second set 11b of battery cells and the third set battery cells 11c at a position spaced apart from the side surface of the first body 311a, a third protrusion 313b protruding from a side of the second body 313a at a first end that is electrically connected to the second electrode terminal 12b of each of the battery ells 11 of the second set 11b of battery cells, and a fourth protrusion 313c protruding from a side surface of the second body 313a at a second end that is electrically connected to the first electrode terminal 12a of each of the battery cells 11 of the third set 11c of battery cells.

The second body 313a may be formed to have a length equal to or similar to a width of the second set 11b of battery cells and the third set 11c of battery cells, and may be positioned at upper portions of the second set 11b of battery cells and the third set 11c of battery cells at a position spaced apart from the side surface of the first body 311a (e.g., the second bus bar 313 may be spaced inward from the first bus bar 311).

The third protrusion 313b may protrude from a side surface of the second body 313a at a first end and be electrically connected to the second electrode terminals 12b of the second set 11b of battery cells.

The third protrusion 313b may protrude as a pair of protrusions at a first end of the second body 313a and may be electrically connected to each of a pair of second electrode terminals 12b of the second set 11b of battery cells (including two battery cells 11) by welding or the like.

The fourth protrusion 313c may protrude from a side surface of the second body 313a and be electrically connected to the first electrode terminal 12a of the third set 11c of battery cells.

The fourth protrusion 313c may protrude as a pair of protrusions at a second end of the second body 313a and may be electrically connected to each of a pair of first electrode terminals 12a of the third set 11c of battery cells (including two battery cells 11) by welding or the like.

Additionally, the second bus bar module 33 may be installed at a second side edge of the cell assembly 10, that is, at an edge position of the cell assembly 10 at a position opposite to a position where the first bus bar module 31 is installed, and may include a plurality of bus bars electrically connecting a plurality of electrode terminals to each other.

In one or more embodiments, the second bus bar module 33 may include a third bus bar 331, a fourth bus bar 333, and a fifth bus bar 335 electrically connected to the electrode terminals along the second side edge of the cell assembly 10.

The third bus bar 331, the fourth bus bar 333, and the fifth bus bar 335 may be positioned adjacent to the second side edge of the cell assembly 10 in a non-contact state with each other and electrically connected to the electrode terminals 12.

The third bus bar 331 may be positioned along the a second side of the cell assembly 10, may have a first side that is electrically connected to the second electrode terminals 12b of the first set 11a of battery cells and a second side that is electrically connected to the first electrode terminals 12a of the second set 11b of battery cells.

The third bus bar 331 may be formed to have a same or similar shape and size as the second bus bar 313, and may be electrically connected to the electrode terminals of the first set 11a of battery cells and the second set 11b of battery cells.

In one or more embodiments, the third bus bar 331 may include a third body 331a at upper portions of the first set 11a of battery cells and the second set 11b of battery cells along the second side of the cell assembly 10, a fifth protrusion 331b protruding from the side surface of the third body 331a and electrically connected to the second electrode terminals 12b of the first set 11a of battery cells, and a sixth protrusion 331c protruding from the side surface of the third body 331a and electrically connected to the first electrode terminals 12a of the second set 11b of battery cells.

The third body 331a may be formed to have a length equal to or similar to a length of a width of the first set 11a of battery cells and the second set 11b of battery cells, and may be positioned at upper portions of the first set 11a of battery cells and the second set 11b of battery cells at the second side edge of the cell assembly 10.

The fifth protrusion 331b may protrude from a side surface of the third body 331a at a first end and be electrically connected to the second electrode terminals 12b of the first set 11a of battery cells.

The fifth protrusion 331b may protrude as a pair of protrusions at a first end of the third body 331a and may be electrically connected to each of a pair of second electrode terminals 12b of the first set 11a of battery cells (including two battery cells 11) by welding or the like.

The sixth protrusion 331c may protrude from a side surface of the third body 331a and be electrically connected to the first electrode terminals 12a of the second set 11b of battery cells. The sixth protrusion may protrude as a pair of protrusions at a second end of the third body 331 and may be electrically connected to each of a pair of first electrode terminals 12a of the second set 11b of battery cells by welding or the like.

The fourth bus bar 333 may include a fourth body 333a positioned at upper portions of the third set 11c of battery cells and the fourth set 11d of battery cells along the second side of the cell assembly 10, and a seventh protrusion 333b protruding from the side surface of the fourth body 333a and electrically connected to the second electrode terminals 12b of the third set 11c of battery cells.

The fourth bus bar 333 may be electrically connected to electrode terminals of the third set 11c of battery cells and positioned at upper portions of the third set 11c of battery cells and the fourth set 11d of battery cells while not contacting the third bus bar 331.

The third body 333a may be formed to have a length equal to or similar to a length of a width of the third set 11c of battery cells and the fourth set 11d of battery cells, and may be positioned at upper portions of the third set 11c of battery cells and the fourth set 11d of battery cells along the second side edge of the cell assembly 10.

The seventh protrusion 333b may protrude as a pair of protrusions at a side surface of the fourth body 333a and may be electrically connected to each of a pair of second electrode terminals 12b of the third set 11c of battery cells (including two battery cells 11) by welding or the like.

In the above-described fourth body 333a, a first current collector 41 may be connected to an end portion at which the fourth set 11d of battery cells is positioned.

The first current collector 41 is connected to the end portion of the fourth body 333a and connected in a protruding state to the outside of the fourth set 11d of battery cells, and thus the first current collector 41 may be installed to enable external connection for current collection and current supply.

Additionally, the fifth bus bar 335 may be positioned on the side surface of the fourth bus bar 333, and may have a first side that is electrically connected to the first electrode terminals 12a of the fourth set 11d of battery cells and a second side that extends to the outside of the fourth set 11d of battery cells.

In one or more embodiments, the fifth bus bar 335 may include a fifth body 335a spaced apart from a side surface of the fourth bus bar 333 and positioned at an upper portion of the fourth set 11d of battery cells, and an eighth protrusion 335b that protrudes from a side surface of the fifth body 335a and is electrically connected to the first electrode terminals 12a of the fourth set 11d of battery cells.

The fifth body 335a may be formed to have a length longer than a length of the width of the fourth set 11d of battery cells, and may be positioned at upper portions of the fourth set 11d of battery cells and have a first end extending to the outside of the fourth set 11d of battery cells.

The eighth protrusion 335b may protrude from a side surface of the fifth body 335a and be electrically connected to the first electrode terminals 12a of the fourth set 11d of battery cells.

The eighth protrusion 335b may protrude as a pair of protrusions on the side surface of the fifth body 335a and may be electrically connected to each of a pair of first electrode terminals 12a of the fourth set 11d of battery cells (including two battery cells 11) by welding or the like.

Additionally, a second current collector 43 may be connected to an end portion protruding from the fifth body 335a to the outside of the fourth set 11d of battery cells.

Accordingly, the second current collector 43 is connected to the end portion of the fifth body 335a to be connected in a protruding state to the outside of the fourth set 11d of battery cells, and thus the second current collector 43 may be installed to enable external connection for current collection and current supply.

As described above, in the rechargeable battery pack 100 of the first embodiment of the present disclosure, the first bus bar module 31 and the second bus bar module 33 constituting the bus bar module 30 may be installed at a first side edge position and a second side edge position, respectively, of the cell assembly 10 without crossing each other in a width direction of the cell assembly 10, and be electrically connected to electrode terminals of the battery cells.

In this manner, the rechargeable battery pack 100 of the present disclosure eliminates a bus bar crossing between opposite sides of a conventional cell assembly.

Accordingly, a more simplified connection structure is possible in a state in which the battery cells 11 of the rechargeable battery pack 100 are connected in parallel by the bus bar module 30. Therefore, it is possible to appropriately reduce heat generated by a current flowing along the bus bars due to the simplification and reduction of the length of the bus bars.

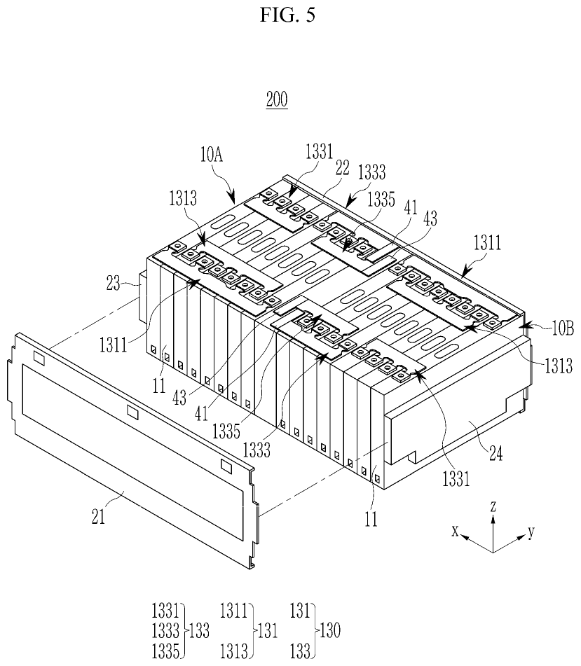

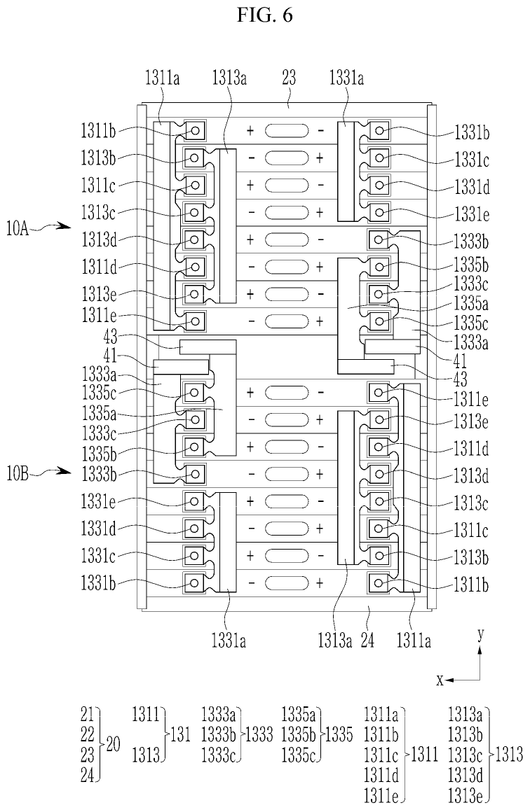

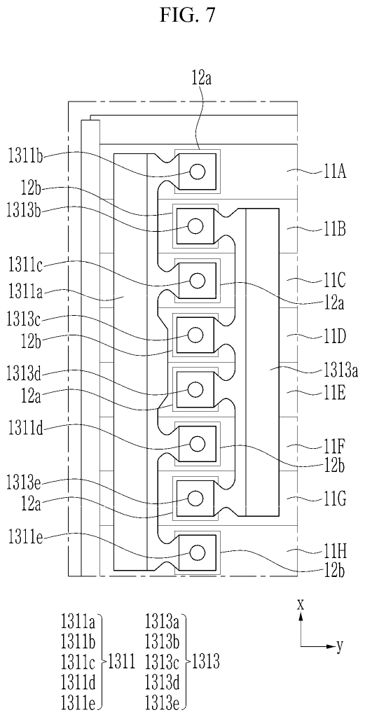

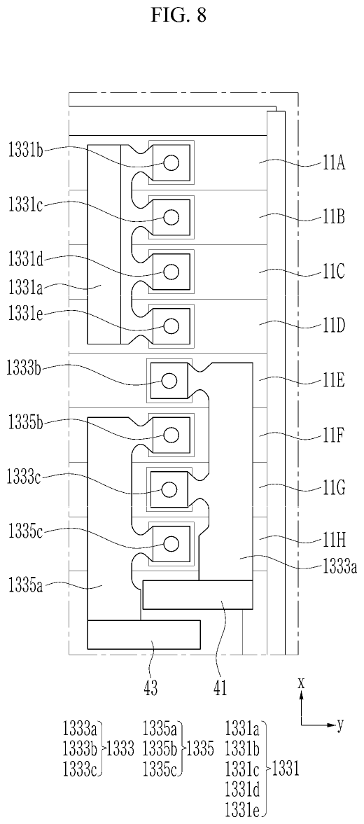

FIG. 5 illustrates a schematic perspective view showing a rechargeable battery pack according to a second embodiment of the present disclosure, FIG. 6 illustrates a schematic top plan view showing a rechargeable battery pack illustrated in FIG. 5, FIG. 7 illustrates a schematic top plan view showing a first bus bar module of the rechargeable battery pack of FIG. 5, and FIG. 8 illustrates a schematic top plan view showing a second bus bar module of the rechargeable battery pack of FIG. 5.

The same reference numerals as those of FIG. 1 to FIG. 4 denote the same or similar members having the same or similar functions. Hereinafter, detailed descriptions of the same reference numerals will be omitted.

As illustrated in FIG. 5 to FIG. 8, for the battery cells 11 according to the secondary battery pack 200 according to the second embodiment of the present disclosure, the battery cells 11 may form the cell assembly 10 by electrically connecting eight battery cells 11 to the bus bar module 30.

The battery cells 11 may be positioned such that electrode terminals of different polarities are respectively positioned at positions adjacent to each other in a configuration in which they are positioned adjacent to each other along a first direction.

The battery cells 11 according to the second embodiment described below may include first to eighth battery cells 11A, 11B, 11C, 11D, 11E, 11F, 11G, and 11H along the first direction, each of which may be adjacently positioned such that first and second electrode terminals having different polarities may be adjacent to each other.

That is, the battery cells 11 are formed to include ordinary rechargeable batteries that repeatedly perform charging and discharging operations, and in the second embodiment, the battery cells 11 will be described as an example in that eight battery cells are electrically connected to the bus bar module 30 to form the cell assembly 10.

Additionally, in the rechargeable battery pack 200 of the second embodiment, two cell assemblies 10 may be installed inside the frame portion 20 in a configuration in which they are positioned to face each other.

The cell assembly 10 may include a first cell assembly 10A inserted into the frame portion 20 and a second cell assembly 10B connected to the first cell assembly 10A. Herein, the first cell assembly 10A and the second cell assembly 10B may have a same configuration, and may be positioned in the frame portion 20 in different directions or orientations. Hereinafter, the same reference numerals are used for main components of the first cell assembly 10A and the second cell assembly 10B.

In the cell assembly 10, a first bus bar module 131 of the first cell assembly 10A and a second bus bar module 133 of the second cell assembly 10B may be positioned on a straight line at a first side of the cell assembly 10 in a configuration where the first cell assembly 10A and the second cell assembly 10B are inserted into the frame portion 20.

In addition, the second bus bar module 133 of the first cell assembly 10A and the first bus bar module 131 of the second cell assembly 10B may be positioned on a straight line with respect to each other at a second side of the cell assembly 10.

The bus bar module 130 may include a first bus bar module 131 electrically connecting a plurality of battery cells at a first side of the cell assembly 10, and a second bus bar module 133 electrically connecting a plurality of battery cells at a second side of the cell assembly 10. The second bus bar module 133 is not directly connected to the first bus bar module 131.

The first bus bar module 131 may include a first parallel bus bar 1311 and a second parallel bus bar 1313 electrically connected to electrode terminals along a first side of the cell assembly 10.

The first parallel bus bar 1311 and the second parallel bus bar 1313 may be positioned adjacent to the first side edge of the cell assembly 10 in a non-contact state with each other and electrically connected to the electrode terminal 12. In one or more embodiments, the first electrode terminal 12a may be a positive terminal, and the second electrode terminal 12b may be a negative terminal. In one or more embodiments, the first electrode terminal 12a may be a negative terminal, and the second electrode terminal 12b may be a positive terminal.

The first parallel bus bar 1311 may be connected to respective electrode terminals of the first battery cell 11A, the third battery cell 11C, the sixth battery cell 11F, and the eighth battery cell 11H.

The first parallel bus bar 1311 may include a first bus bar body 1311a positioned along a first side of the cell assembly 10 and positioned at upper portions of the first to eighth battery cells 11H at first sides, and a first connector 1311b, a second connector 1311c, a third connector 1311d, and a fourth connector 1311e protruding from a side surface of the first bus bar body 1311a.

The first bus bar body 1311a may be formed to have a sufficiently long length so as to cross upper portions of the first to eighth battery cells 11A to 11H at an upper portion of a first side edge of the cell assembly 10.

The first connector 1311b may protrude from a side surface of the first bus bar body 1311a at a first end and be electrically connected to the first electrode terminal 12a of the first battery cell 11A.

The first connector 1311b may be a single protrusion protruding from the side surface of the first bus bar body 1311a at the first end and electrically connected to the first electrode terminal 12a of the first battery cell 11A by welding or the like.

The second connector 1311c may protrude from the side surface of the first bus bar body 1311a and be electrically connected to the first electrode terminal 12a of the third battery cell 11C. The second connector 1311c may be a single protrusion protruding from the side surface of the first bus bar body 1311a and be electrically connected to the first electrode terminal 12a of the third battery cell 11C by welding or the like.

The third connector 1311d may protrude from the side surface of the first bus bar body 1311a and be electrically connected to the second electrode terminal 12b of the sixth battery cell 11F. The third connector 1311d may be a single protrusion protruding from the side surface of the first bus bar body 1311a and be electrically connected to the second electrode terminal 12b of the sixth battery cell 11F by welding or the like.

The fourth connector 1311e may protrude from the side surface of the first bus bar body 1311a at a second end and be electrically connected to the second electrode terminal 12b of the eighth battery cell 11H. The fourth connector 1311e may be a single protrusion protruding from the side surface of the first bus bar body 1311a and be electrically connected to the second electrode terminal 12b of the eighth battery cell 11H by welding or the like.

The second parallel bus bar 1313 may be electrically connected to respective electrode terminals 12a, 12b of the second battery cell 11B, the fourth battery cell 11D, the fifth battery cell 11E, and the seventh battery cell 11G at a position spaced apart from the side surface of the first parallel bus bar 1311.

The second parallel bus bar 1313 may include a second bus bar body 1313a positioned at upper portions of the second to seventh battery cells 11B to 11G at first sides on the side surface of the first bus bar body 1311a along a first side of the cell assembly 10, and a fifth connector 1313b, a sixth connector 1313c, a seventh connector 1313d, and an eighth connector 1313e protruding from the side surface of the second bus bar body 1313a.

The second bus bar body 1313a may be formed to have a sufficiently long length so as to cross upper portions of the second to seventh battery cells 11B to 11G at a position spaced apart from the side surface of the first bus bar body 1311a at an upper portion of a first side edge of the cell assembly 10.

The fifth connector 1313b may be a single protrusion protruding from the side surface of the second bus bar body 1313a at a first end and be electrically connected to the second electrode terminal 12b of the second battery cell 11B at a position between the first connector 1311b and the second connector 1311c by welding or the like.

The sixth connector 1313c may protrude from the side surface of the second bus bar body 1313a and be electrically connected to the second electrode terminal 12b of the fourth battery cell 11D at a position between the second connector 1311c and the third connector 1311d.

The fifth connector 1313d may protrude from the side surface of the second bus bar body 1313a and be electrically connected to the first electrode terminal 12a of the fifth battery cell 11E at a position between the second connector 1311c and the third connector 1311d.

The eighth connector 1313e may protrude from the side surface of the second bus bar body 1313a and be electrically connected to the first electrode terminal 12a of the seventh battery cell 11G at a position between the third connector 1311d and the fourth connector 1311e.

Additionally, the second bus bar module 133 may be installed at a second side edge of the cell assembly 10, that is, at an edge position of the cell assembly 10 at a position opposite to a position where the first bus bar module 131 is installed, and may include a plurality of bus bars electrically connecting a plurality of electrode terminals to each other.

In one or more embodiments, the second bus bar module 133 may include a third parallel bus bar 1331, a fourth parallel bus bar 1333, and a fifth parallel bus bar 1335 electrically connected to the electrode terminals along the second side of the cell assembly 10.

The third parallel bus bar 1331 may include a third bus bar body 1331a positioned along the second side of the cell assembly 10 and positioned at upper portions of the first to fourth battery cells 11A to 11D at second sides, and a ninth connector 1331b, a tenth connector 1331c, an eleventh connector 1331d, and a twelfth connector 1331e protruding from the side surface of the third bus bar body 1331a and electrically connected to the electrode terminal.

The third bus bar body 1331a may be formed to have a sufficiently long length so as to cross upper portions of the first to fourth battery cells 11A to 11D at an upper portion of a second side edge of the cell assembly 10.

The ninth connector 1331b may be a single protrusion protruding from the side surface of the third bus bar body 1331a at the first end and be electrically connected to the second electrode terminal 12b of the first battery cell 11A by welding or the like.

The tenth connector 1331c may be disposed at a side surface of the ninth connector 1331b and may protrude from a side surface of the third bus bar body 1331a and be electrically connected to the first electrode terminal 12a of the second battery cell 11B by welding or the like.

The eleventh connector 1331d may be disposed at a side surface of the tenth connector 1331c and may protrude from the side surface of the third bus bar body 1331a and be electrically connected to the second electrode terminal 12b of the third battery cell 11C by welding or the like.

The twelfth connector 1331e may be disposed at a side surface of the eleventh connector 1331d and may protrude from the side surface of the third bus bar body 1331a and be electrically connected to the first electrode terminal 12a of the fourth battery cell 11D by welding or the like.

Additionally, the fourth parallel bus bar 1333 may include a fourth bus bar body 1333a positioned along the second side of the cell assembly 10 and positioned at upper portions of the fifth battery cell 11E to the eighth battery cell 11H, and a 13^{th} connector 1333b and a 14^{th} connector 1333c protruding from the side surface of the fourth bus bar body 1333a.

The fourth bus bar body 1333a may be formed to have a sufficiently long length so as to cross upper portions of the fifth to eighth battery cells 11E to 11H at an upper portion of a second side edge of the cell assembly 10.

In the fourth bus bar body 1333a, the first current collector 41 may be connected to an end portion positioned at an upper portion of the eighth battery cell 11H from the outside of the eighth battery cell 11H.

The 13^{th} connector 1331b may be a single protrusion protruding from the side surface of the fourth bus bar body 1333a at a first end and be electrically connected to the second electrode terminal 12b of the fifth battery cell 11E by welding or the like.

The 14^{th} connector 1333c may be a single protrusion protruding from the side surface of the fourth bus bar body 1333a at a first end and be electrically connected to the second electrode terminal 12b of the seventh battery cell 11G by welding or the like.

Additionally, the fifth parallel bus bar 1335 may include a fifth bus bar body 1335a positioned along the second side of the cell assembly 10 and positioned at upper portions of the sixth to eighth battery cells 11F to 11H, and a 15^{th} connector 1335b and a 16^{th} connector 1335c protruding from the side surface of the fifth bus bar body 1335a.

The fifth bus bar body 1335a may be formed to have a sufficiently long length so as to cross upper portions of the sixth battery cells 11F to the eighth battery cells 11H at a position spaced apart from the side surface of the fourth bus bar body 1333a.

In the fifth bus bar body 1335a, the second current collector 43 may be connected to an end portion positioned at an upper portion of the eighth battery cell 11H from the outside of the eighth battery cell 11H.

The 15^{th} connector 1335b may protrude from the side surface of the fifth bus bar body 1335a between the 13^{th} connector 1333b and the 14^{th} connector 1333c and be electrically connected to the first electrode terminal 12a of the sixth battery cell 11F.

The 16^{th} connector 1335c may protrude from the side surface of the fifth bus bar body 1335a and be electrically connected to the first electrode terminal 12a of the eighth battery cell 11H.

As described above, in the rechargeable battery pack 200 of the second embodiment of the present disclosure, the first bus bar module 131 and the second bus bar module 133 constituting the bus bar module 130 may be installed at a first side edge position and a second side edge position of the cell assembly 10 without crossing each other in a width direction of the cell assembly 10 and electrically connected to electrode terminals of the battery cells.

Accordingly, compared to related art battery packs, a more simplified connection structure is possible in which the battery cells 11 of the rechargeable battery pack 200 are connected in parallel by the bus bar module 130. Therefore, it is possible to appropriately reduce heat generated by a current flowing along the bus bars due to the simplification and reduction of the length of the bus bars.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

10: cell assembly 10a, 10A: first cell assembly
10b, 10B: second cell assembly 11: battery cell
11a: first set of battery cells 11b: second set of battery cells
11c: third set of battery cells 11d: fourth set of battery cells
11A: first battery cell 11B: second battery cell
11C: third battery cell 11D: fourth battery cell
11E: fifth battery cell 11F: sixth battery cell
11G: seventh battery cell 11H: eighth battery cell
20: frame portion 21: first side frame
22: second side frame 23: first end frame
24: second end frame 30, 130: bus bar module
31, 131: first bus bar module 311: first bus bar
311a: first body 311b: first protrusion
311c: second protrusion 313: second bus bar
313a: second body 313b: third protrusion
313c: fourth protrusion 33, 133: second bus bar module
331: third bus bar 331a: third body
331b: fifth protrusion 331c: sixth protrusion
333: fourth bus bar 333a: fourth body
333b: seventh protrusion 335: fifth bus bar
335a: fifth body 335b: eighth protrusion
41: first current collector 43: second current collector
1311: first parallel bus bar 1311a: first bus bar body
1311b: first connector 1311c: second connector
1311d: third connector 1311e: fourth connector
1313: second parallel bus bar 1313a: second bus bar body
1313b: fifth connector 1313c: sixth connector
1311d: seventh connector 1313e: eighth connector
1331: third parallel bus bar 1313a: third bus bar body
1331b: ninth connector 1331c: tenth connector
1331d: eleventh connector 1331e: twelfth connector
1333: fourth parallel bus bar 1333a: fourth bus bar body
1333b: 13^{th} connector 1333c: 14^{th} connector
1335: fifth parallel bus bar 1335a: fifth bus bar body
1335b: 15^{th} connector 1335c: 16^{th} connector

1. A rechargeable battery pack comprising:
a cell assembly comprising a plurality of battery cells and a plurality of electrode terminals, each battery cell of the plurality of battery cells comprising a first electrode terminal and a second electrode terminal protruding upward from the respective battery cell;
a frame portion configured to accommodate the cell assembly; and
a bus bar module comprising a plurality of bus bars positioned at an upper portion of the cell assembly and electrically connecting at least two electrode terminals to each other,
wherein the bus bar module includes:
a first bus bar module comprising a plurality of bus bars electrically connecting the plurality of electrode terminals to each other at a first side of the cell assembly; and
a second bus bar module comprising a plurality of bus bars electrically connecting the plurality of electrode terminals to each other at a second side of the cell assembly.

2. The rechargeable battery pack of claim 1, wherein
side surfaces of the plurality of battery cells are in contact with each other along a first direction.

3. The rechargeable battery pack of claim 2, wherein:
the plurality of battery cells comprise a first set of battery cells, a second set of battery cells, a third set of battery cells, and a fourth set of battery cells,
each of the first set, the second set, the third set, and the fourth set comprises a pair of battery cells adjacent to each other, and
in each of the first set, the second set, the third set, and the fourth set, electrode terminals of the pair of battery cells having the same polarities are adjacent to each other along the first direction.

4. The rechargeable battery pack of claim 3, wherein
the first bus bar module comprises:
a first bus bar along a first side of the cell assembly and having a first side electrically connected to a first electrode terminal of the first set of battery cells and a second side electrically connected to a second electrode terminal of the fourth set of battery cells; and
a second bus bar on a side surface of the first bus bar and having a first side electrically connected to a second electrode terminal of the second set of battery cells and a second side electrically connected to a first electrode terminal of the third set of battery cells.

5. The rechargeable battery pack of claim 4, wherein the second bus bar module comprises:
a third bus bar along a second side of the cell assembly and having a first side electrically connected to a second electrode terminal of the first set of battery cells and a second side electrically connected to a first electrode terminal of the second set of battery cells;
a fourth bus bar along the second side of the cell assembly and having a first side electrically connected to a second electrode terminal of the third set of battery cells, and a second side that extends to the outside of the cell assembly; and
a fifth bus bar on a side surface of the fourth bus bar and having a first side electrically connected to a first electrode terminal of the fourth set of battery cells, and a second side that extends to the outside of the fourth set of battery cells.

6. The rechargeable battery pack of claim 5, wherein
the first bus bar comprises:
a first body at upper portions of first sides of the first to fourth sets of battery cells at first sides on the first side of the cell assembly;
a first protrusion protruding from a side surface of the first body at a first end and be electrically connected to the first electrode terminal of the first set of battery cells; and
a second protrusion protruding from a side surface of the first body at a second end and be electrically connected to the second electrode terminal of the fourth set of battery cells.

7. The rechargeable battery pack of claim 6, wherein
the first protrusion comprises a pair of first protrusions
on the side surface of the first body at a first end, the pair of first protrusions being electrically connected to the first electrode terminal of each battery cell in the first set of battery cells.

8. The rechargeable battery pack of claim 7, wherein
the second protrusion comprises a pair of second protrusions
on the side surface of the first body at a second end, the pair of second protrusions being electrically connected to the second electrode terminal of each battery cell in the fourth set of battery cells.

9. The rechargeable battery pack of claim 8, wherein
the second bus bar comprises:
a second body at upper portions of the second set of battery cells and the third set of battery cells, the second body being spaced apart from the side surface of the first body;
a third protrusion protruding from a side surface of the second body, the third protrusion being electrically connected to the second electrode terminal of each battery cell in the second set of battery cells; and
a fourth protrusion protruding from a side surface of the second body, the fourth protrusion being electrically connected to the first electrode terminal of each battery cell in the third set of battery cells.

10. The rechargeable battery pack of claim 9, wherein
the third protrusion comprises a pair of third protrusions
on the side surface of the second body, the pair of third protrusions being electrically connected to the second electrode terminal of each battery cell in the second set of battery cells.

11. The rechargeable battery pack of claim 10, wherein
the fourth protrusion comprises a pair of fourth protrusions
on the side surface of the second body, the pair of fourth protrusions being electrically connected to the first electrode terminal of each battery cell in the third set of battery cells.

12. The rechargeable battery pack of claim 11, wherein
the third bus bar comprises:
a third body at upper portions of the first set of battery cells and the second set of battery cells along the second side of the cell assembly;
a fifth protrusion protruding from a side surface of the third body and electrically connected to the second electrode terminal of each battery cell in the first set of battery cells; and
a sixth protrusion protruding from the side surface of the third body and electrically connected to the first electrode terminal of each battery cell in the second set of battery cells.

13. The rechargeable battery pack of claim 12, wherein
the fifth protrusion comprises a pair of fifth protrusions
on the side surface of the second body, the pair of fifth protrusions being electrically connected to the second electrode terminal of each battery cell in the first set of battery cells.

14. The rechargeable battery pack of claim 13, wherein
the sixth protrusion comprises a pair of sixth protrusions
on the side surface of the third body, the pair of sixth protrusions being electrically connected to the first electrode terminal of each battery cell in the second set of battery cells.

15. The rechargeable battery pack of claim 14, wherein
the fourth bus bar comprises:
a fourth body at upper portions of the third set of battery cells and the fourth set of battery cells along the second side of the cell assembly; and
a seventh protrusion protruding from a side surface of the fourth body, the seventh protrusion being electrically connected to the second electrode terminal of each battery cell in the third set of battery cells.

16. The rechargeable battery pack of claim 15, wherein
the fourth body is connected to the first current collector outside the fourth set of battery cells.

17. The rechargeable battery pack of claim 16, wherein
the seventh protrusion comprises a pair of seventh protrusions
on the side surface of the fourth body, the pair of seventh protrusions being electrically connected to the second electrode terminal of each battery cell in the third set of battery cells.

18. The rechargeable battery pack of claim 17, wherein
a portion of the fourth body is positioned at upper portions of the fourth set of battery cells in which the fourth set of battery cells are not electrically connected to the portion of the fourth body.

19. The rechargeable battery pack of claim 18, wherein
the fifth bus bar comprises:
a fifth body spaced apart from a side surface of the fourth bus bar and positioned at the upper portions of the fourth set of battery cells; and
an eighth protrusion protruding from the side surface of the fifth body and electrically connected to the first electrode terminal of each battery cell in the fourth set of battery cells.

20. The rechargeable battery pack of claim 19, wherein
the eighth protrusion comprises a pair of eighth protrusions
on the side surface of the fifth body, the pair of eighth protrusions being electrically connected to the first electrode terminal of each battery cell in the fourth set of battery cells.

21. The rechargeable battery pack of claim 20, wherein
the fifth body is connected to the second current collector outside the fourth set of battery cells.

22. The rechargeable battery pack of claim 21, wherein
the cell assembly comprises two cell assemblies inside the frame portion and positioned in opposite directions.

23. The rechargeable battery pack of claim 1, wherein
the electrode terminals of adjacent battery cells of the plurality of battery cells have different polarities along a first direction.

24. The rechargeable battery pack of claim 23, wherein
the cell assembly comprises a first battery cell, a second battery cell, a third battery cell, a fourth battery cell, a fifth battery cell, a sixth battery cell, a seventh battery cell, and an eighth battery cell.

25. The rechargeable battery pack of claim 24, wherein
the first bus bar module comprises:
a first parallel bus bar along a first side of the cell assembly and electrically connected to an electrode terminal of each of the first battery cell, the third battery cell, the sixth battery cell, and the eighth battery cell; and
a second parallel bus bar along the first side of the cell assembly and electrically connected to an electrode terminal of each of the second battery cell, the fourth battery cell, the fifth battery cell, and the seventh battery cell.

26. The rechargeable battery pack of claim 25, wherein
the second bus bar module comprises:
a third parallel bus bar along the second side of the cell assembly and electrically connected to the electrode terminal of each of the first battery cell, the second battery cell, the third battery cell, and the fourth battery cell;
a fourth parallel bus bar along the second side of the cell assembly and electrically connected to the electrode terminal of each of the fifth battery cell and the seventh battery cell; and
a fifth parallel bus bar along the second side of the cell assembly and electrically connected to the electrode terminal of each of the sixth battery cell and the eighth battery cell.

27. The rechargeable battery pack of claim 26, wherein
the first parallel bus bar comprises:
a first bus bar body positioned along the first side of the cell assembly and positioned at upper portions of the first to eighth battery cells;
a first connector protruding from a side surface of the first bus bar body and electrically connected to the first electrode terminal of the first battery cell;
a second connector protruding from the side surface of the first bus bar body and electrically connected to the first electrode terminal of the third battery cell;
a third connector protruding from the side surface of the first bus bar body and electrically connected to the second electrode terminal of the sixth battery cell; and
a fourth connector protruding from a side surface of the first bus bar body and electrically connected to the second electrode terminal of the eighth battery cell.

28. The rechargeable battery pack of claim 27, wherein
the second parallel bus bar comprises:
a second bus bar body alongside the first bus bar body along the first side of the cell assembly and positioned at upper portions of the second battery cell, the third battery cell, the fourth battery cell, the fifth battery cell, the sixth battery cell, and the seventh battery cell;
a fifth connector protruding from a side surface of the second bus bar body and electrically connected to a second electrode terminal of the second battery cell;
a sixth connector protruding from a side surface of the second bus bar body and electrically connected to a second electrode terminal of the fourth battery cell;
a seventh connector protruding from the side surface of the second bus bar body and electrically connected to a first electrode terminal of the fifth battery cell; and
an eighth connector protruding from the side surface of the second bus bar body and electrically connected to a first electrode terminal of the seventh battery cell.

29. The rechargeable battery pack of claim 28, wherein
the third parallel bus bar comprises:
a third bus bar body along the second side of the cell assembly and positioned at upper portions of the first battery cell, the second battery cell, the third battery cell, and the fourth battery cell;
a ninth connector protruding from the side surface of the third bus bar body and electrically connected to a second electrode terminal of the first battery cell;
a tenth connector protruding from the side surface of the third bus bar body and electrically connected to a first electrode terminal of the second battery cell;
an eleventh connector protruding from the side surface of the third bus bar body and electrically connected to a second electrode terminal of the third battery cell; and
a twelfth connector protruding from the side surface of the third bus bar body and electrically connected to a first electrode terminal of the fourth battery cell.

30. The rechargeable battery pack of claim 29, wherein
the fourth parallel bus bar comprises:
a fourth bus bar body along the second side of the cell assembly and positioned at upper portions of the fifth battery cell, the sixth battery cell, the seventh battery cell, and the eighth battery cell;
a thirteenth connector protruding from the side surface of the fourth bus bar body and electrically connected to a second electrode terminal of the fifth battery cell; and
a fourteenth connector protruding from the side surface of the fourth bus bar body and electrically connected to a second electrode terminal of the seventh battery cell.

31. The rechargeable battery pack of claim 30, wherein
the fourth bus bar body is connected to the first current collector outside the eighth battery cell.

32. The rechargeable battery pack of claim 31, wherein
the fifth parallel bus bar comprises:
a fifth bus bar body along the second side of the cell assembly and positioned at upper portions of the sixth battery cell, the seventh battery cell, and the eighth battery cell;
a fifteenth connector protruding from the side surface of the fifth bus bar body and electrically connected to a first electrode terminal of the sixth battery cell; and
a sixteenth connector protruding from the side surface of the fifth bus bar body and electrically connected to a first electrode terminal of the eighth battery cell.

33. The rechargeable battery pack of claim 32, wherein
fifth bus bar body is connected to the second current collector outside the eighth battery cell.

34. The rechargeable battery pack of claim 33, wherein
the cell assembly comprises two cell assemblies inside the frame portion and positioned in opposite directions.
